(19) United States
(12) Patent Application Publication
(10) Pub. No.: US 2009/0037380 A1
(43) Pub. Date: Feb. 5, 2009

(54) System and method for providing integrated search using URI database

(75) Inventors: Han Min Jung, Daejeon (KR); In Su Kang, Daejeon (KR); Pyung Kim, Daejeon (KR); Mi Kyung Lee, Gyeongsangbuk-do (KR); Seung Woo Lee, Daejeon (KR); Won Kyung Sung, Daejeon (KR); Dong In Park, Seoul (KR); Sun Hwa Hahn, Daejeon (KR)

Correspondence Address: STEPTOE & JOHNSON LLP, 1330 CONNECTICUT AVENUE, N.W., WASHINGTON, DC, 20036, US

(73) Assignee: Korea Institute of Science & Technology Information, Daejeon (KR)

(21) Appl. No.: 11/905,957

(22) Filed: Oct. 5, 2007

(30) Foreign Application Priority Data
Jul. 30, 2007 (KR) 10-2007-0076312

(51) Int. Cl. G06F 17/30

(52) U.S. Cl. 707/3; 707/E17.008

(57) ABSTRACT

Provided is a system for providing integrated search using a URI database, the system including a URI database that stores associated information corresponding to a specific entity as object identifiers; an entity information processing unit that searches a URI database in accordance with a query input of a user so as to check the type of an entity and provides entity information; and an integrated-search result providing unit that provides an integrated-search result page for the corresponding entity, based on the entity information provided from the entity information processing unit.

### BACKGROUND OF THE INVENTION

1. Field of the Invention

The present invention relates to a system and method for providing integrated search using a URI (Uniform Resource Identifier) database, which automatically recognizes the type of a query from a user by using a URI database and provides an integrated-search result based on the type of the query. The system and method can be easily used in all fields in which an elaborate search service based on an object identifier is required.

2. Description of the Related Art

In general, integrated search is widely applied to information search within companies as well as web portal sites. However, the integrated search is based on a keyword composed of simple character strings.

Recently, a few portal sites provide a search result page, focused on entity information, for a person's name and the names of several entities. In many cases, however, the search result page based on a character string includes a wrong search result, because a problem caused by persons with the same name is not sufficiently overcome.

For example, when ‘Lee Sun-hui’ is searched on Naver (which is the most popular portal site in Korea), a web page for persons with the same name, composed of a singer, a person associated with a welfare organization, a golfer and so on, is displayed. The discrimination between the persons is performed through detailed queries such as ‘Lee sun-hui, the singer’, ‘Lee sun-hui, the person associated with a welfare organization’, and ‘Lee sun-hui, the golfer’. Therefore, an inappropriate search result may be included, or the persons with the same name and the same occupation may not be discriminated.

Accordingly, there is a need for providing an elaborate information search service which can automatically recognize an entity on the basis of an object identifier such as a URI and then present an integrated search result for the entity.

### SUMMARY OF THE INVENTION

An advantage of the present invention is that it provides a system and method for providing integrated search using a URI database, which stores associated information on a specific entity, checks the type of the entity when a query input of a user is the registered entity, and construct a page for each entity depending on the type of the entity. Therefore, the system and method can provide a search result specified on a specific entity.

Another advantage of the invention is that it provides a system and method for providing integrated search using a URI database, which calls open APIs such as Google Maps, Amazon E-commerce and so on by using entity information so as to acquire external information, calls a Semantic-web-based inference system so as to acquire additional information, and performs a mash-up on the acquired information to provide as a portion of an integrated-search result.

Additional aspects and advantages of the present general inventive concept will be set forth in part in the description which follows and, in part, will be obvious from the description, or may be learned by practice of the general inventive concept.

According to an aspect of the invention, a system for providing integrated search using a URI database comprises a URI database that stores associated information corresponding to a specific entity as object identifiers; an entity information processing unit that searches a URI database in accordance with a query input of a user so as to check the type of an entity and provides entity information; and an integrated-search result providing unit that provides an integrated-search result page for the corresponding entity, based on the entity information provided from the entity information processing unit.

Preferably, the system further comprises a mash-up processing unit that calls an open API (Application Program Interface) on the basis of the entity information provided from the entity information processing unit, calls an inference system, and performs a mash-up by using the corresponding result.

Preferably, the mash-up processing unit includes an open API calling section which calls an open API on the basis of the entity information provided from the entity information processing unit; an inference calling section which calls an inference system on the basis of the entity information provided from the entity information processing unit; and a mash-up constructing section which constructs a mash-up on the basis of open API information provided from the open API calling section and inference information provided from the inference calling section.

Preferably, the entity information processing unit includes a query receiving section which receives a query from the user; a URI database searching section which searches for an entity matching the query through the URI database; an entity type checking section which checks the type of the entity, based on the search result of the URI database searching section; and an entity information providing section which provides entity information, depending on the type of the entity, the entity information including associated information on the corresponding entity.

Preferably, the integrated-search result providing unit calls an open API or/and an inference system, inserts the entity information provided from the entity information processing unit into a web page so as to construct a page for each entity, and presents the page as an integrated-search result.

Preferably, the integrated-search result providing unit includes a mash-up calling section which receives a mash-up result module from the mash-up processing unit; an open API calling section which calls an open API; an inference calling section which calls an inference system; an entity page constructing section which constructs a page for each entity, based on the mash-up result module provided from the mash-up calling section, the open API provided from the open API calling section, the inference system provided from the inference calling section, and the entity information provided from the entity information processing unit; and an integrated-search result presenting section which provides the page for each entity through a web interface.

According to another aspect of the invention, method for providing integrated search using a URI database comprises the steps of: (a) storing associated information corresponding to a specific entity, as object identifiers, into a URI database; (b) searching the URI database in accordance with a query input of a user so as to check the type of the entity; (c) providing entity information depending on the type of the entity; and (d) providing an integrated-search result page for the corresponding entity, based on the provided entity information.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a diagram showing the configuration of a system for providing integrated search using a URI database according to the present invention;

FIG. 2 is a block diagram of the system for providing integrated search using a URI database according to the invention;

FIG. 3 is a diagram showing a process in which an entity information processing unit provides entity information; and

FIG. 4 is a diagram showing an integrated-search result page according to the invention.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

Hereinafter, embodiments of the present invention will be described in detail with reference to the accompanying drawings.

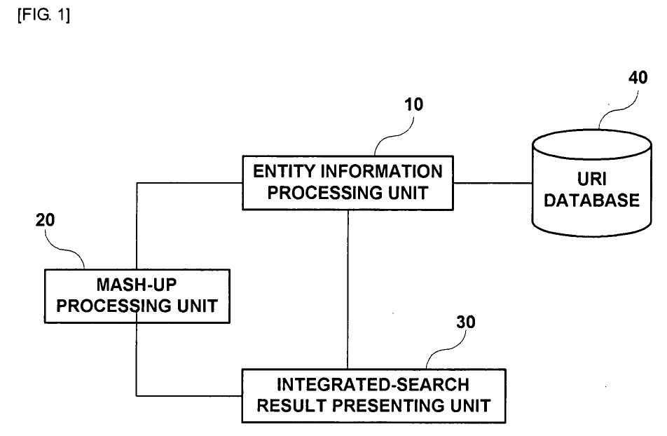

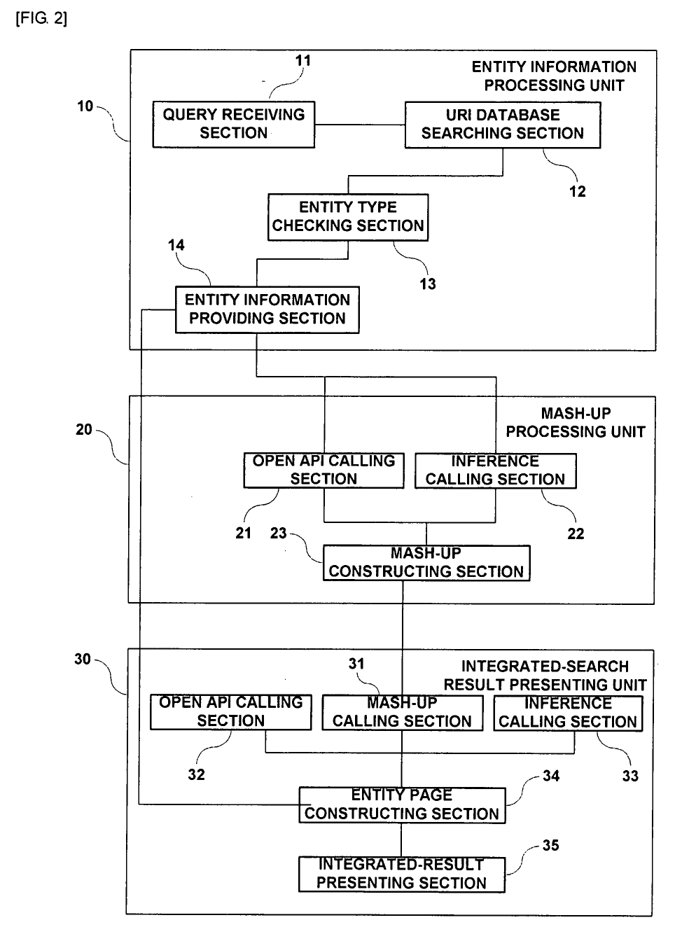

FIG. 1 is a diagram showing the configuration of a system for providing integrated search using a URI database according to the invention. FIG. 2 is a block diagram of the system for providing integrated search using a URI database according to the invention.

Referring to FIGS. 1 and 2, the system for providing integrated search using a URI database according to the invention includes an entity information processing unit 10 which searches a URI database in accordance with a query input of a user so as to check the type of an entity and provides entity information; a mash-up processing unit 20 which receives the entity information from the entity information processing unit 10 so as to perform a mesh-up on the corresponding entity by using an open API, an inference system and so on; an integrated-search result providing unit 30 which receives the entity information from the entity information processing unit 10 and a mash-up result module from the mash-up processing unit 20 so as to construct an integrated-search result page for the corresponding entity; and the URI database 40. The URI is referred to as a character sting for discriminating information resources and is a unique name granted to an information resource.

The entity information processing unit 10 searches through the URI database whether an entity is a registered entity or not, in accordance with a query input of a user. Further, the entity information processing unit 10 checks the type of the corresponding entity and provides the entity information to the mash-up processing unit 20 and the integrated-search result providing unit 30.

The entity information processing unit 10 includes a query receiving section 11 which receives a query from a user; a URI database searching section 12 which searches for an entity matching the query through the URI database; an entity type checking section 13 which checks the type of the entity through a search result of the URI database searching section 12; and an entity information providing section 14 which provides entity information on the corresponding entity to the mash-up processing unit 20 and the integrated-search result providing unit 30.

The query receiving section 11 receives a query from a user through a search window.

The URI database searching section 12 searches the query in associated information on a specific entity stored in the URI database and then provides the corresponding search result to the entity type checking section 13.

The entity type checking section 13 checks a type to which the searched entity belongs and determines which entity page is to be configured.

The entity information providing section 14 reads entity information on the corresponding entity from the URI database and then provides the entity information and the entity type determined by the entity type checking section 13 to the mesh-up processing unit 20 and the integrated-search result providing unit 30.

The mash-up processing unit 20 calls an open API by using the entity information provided from the entity information providing section 14 within the entity information processing unit 10. Then, the mash-up processing unit 20 calls the inference system and performs a mash-up by using the result.

The mash-up processing unit 20 includes an open API calling section 21 which calls open APIs such as Google Maps, Amazon E-commerce and so on by using the entity information provided from the entity information providing section 14; an inference calling section 22 which calls an inference system by using the entity information provided from the entity information providing section 14; and a mash-up constructing section 23 which performs a mash-up based on external information acquired through the open API calling section 21 and additional information acquired through the inference calling section 22.

The open API calling section 21 calls an open API by using a web service or java script, with the entity information set to a parameter, and then acquires the result.

The inference calling section 22 calls the inference system, with the entity information set to a parameter, and then acquires the result. At this time, the inference system is a Semantic-web-based inference system. The Semantic web provides a function in which a computer itself can recognize the meaning of information connected to the web, search for information required by a user, and infer knowledge from the searched information.

The mash-up constructing section 23 visually constructs a mash-up service by using the external information acquired through the open API calling section 21 and the additional information acquired through the inference calling section 22.

The integrated-search result providing unit 30 receives a mash-up result module from the mash-up constructing section 23 so as to insert into a page for each entity, calls an open API and the inference system, constructs a page for each entity by inserting the entity information provided from the entity information providing section 14 into the page, and presents the page as an integrated-search result.

The integrated-search result providing unit 30 includes a mash-up calling section 31 which calls a mash-up result module from the mash-up constructing section 23; an open API calling section 32 which calls an open API so as to provide an open API service; an inference calling section 33 which calls the inference system so as to acquire an inference result; a entity page constructing section 34 which combines entity information provided from the mash-up calling section 31, the open API calling section 32, the inference calling section 33, and the entity information providing section 14 so as to construct a page for each entity; and an integrated-result presenting section 35 which presents the page for each entity through a web interface.

The mash-up calling section 31 acquires a URL, through which it can access the mash-up result module of the mash-up constructing section 23, or receives a code such as a java script or the like.

The open API calling section 32 calls an open API by using a web service or java script, with the entity information set to a parameter, and then acquires the result.

The inference calling section 33 calls the inference system, with the entity information set to a parameter, and then acquires the result.

The entity page constructing section 34 combines the entity information provided from the mash-up calling section 31, the open API calling section 32, the inference calling section 33, and the entity information providing section 14 so as to construct a page for each entity.

Further, when a specific entity has various identifiers because there are several persons with the same name as that of the entity, a selection box or the like is provided on an interface such that a user can select a desired identifier. For example, Cyworld (which is one of social networking sites in Korea) simultaneously provides the birth dates of persons with the same name such that a desired person can be accurately selected. Even in this kind of service, however, since the identifiers are not perfectly shown, persons with the same name and the same birth date are still present.

The integrated-search result presenting section 35 present the page for each entity, constructed by the entity page constructing section 34, through a web interface and so on.

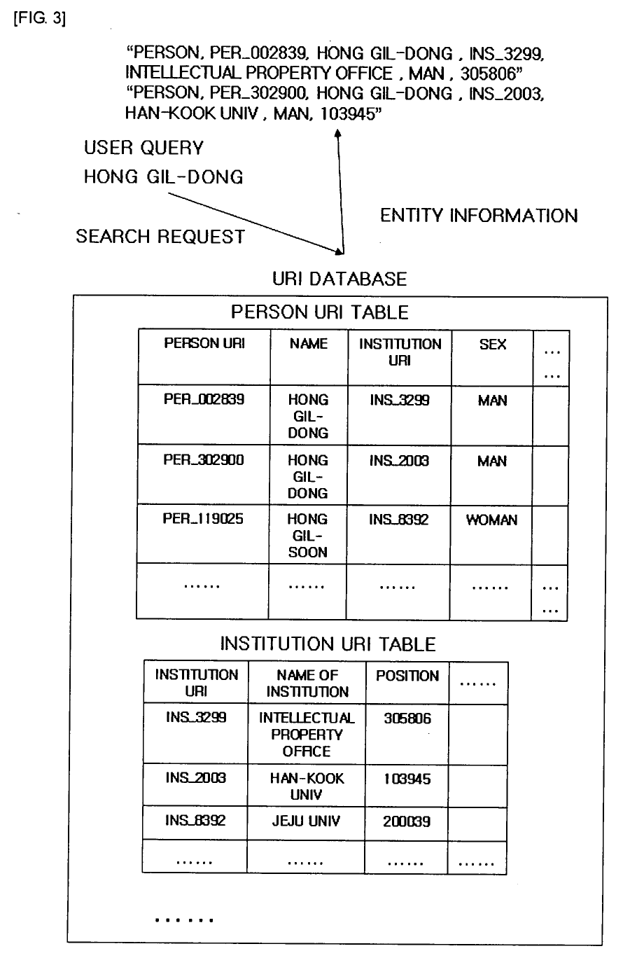

FIG. 3 is a diagram showing a process in which the entity information processing unit provides entity information.

Referring to FIG. 3, the entity information processing unit searches for an entity matching a query in the respective fields of the URI database, when the query is input from a user. If there is no entity which accurately matches the query, an entity which partially matches the query is searched for. When an entity which accurately matches the query is searched for from a person URI table shown in FIG. 3, all associated information is searched for by using a foreign key and so on and is then provided as entity information.

For example, as shown in FIG. 3, when two entities are searched for on a query of ‘Hong Gil-Dong’, the types of the entities are checked. Then, the type of a page for each entity is determined, which is to be constructed for the entity which entirely or partially matches the query. If a plurality of entities having the same character string are present under the same type, the priorities thereof are determined in order of names and birth dates. Then, a web page for each entity can be constructed in such a manner that the entity can be selected on the page of the entity.

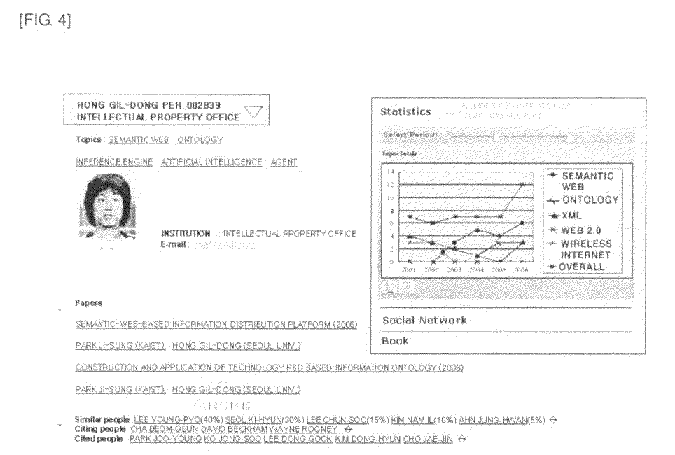

FIG. 4 is a diagram showing an integrated-search result page according to the invention.

Referring to FIG. 4, a page for entity is constructed on the basis of entity information provided from the open API calling section 32, the inference calling section 33, and the entity information providing section 14, when an entity type is Person. In this case, persons with the same name are present. Therefore, a URI-based selection box is provided on the upper side of the screen such that desired information can be accurately selected.

According to the invention, it is possible to provide a system and method for providing integrated search using a URI database, which stores associated information on a specific entity, checks the type of the entity when a query input of a user is the registered entity, and constructs a page for each entity depending on the type of the entity. The system and method can provide a search result specified on a specific entity.

Further, it is possible to provide a system and method for providing integrated search using a URI database, which calls open APIs such as Google Maps, Amazon E-commerce and so on by using entity information so as to acquire external information, calls a Semantic-web-based inference system so as to acquire additional information, and performs a mash-up on the acquired information to provide as a portion of an integrated-search result.

Furthermore, it is possible to provide a system and method for providing integrated search using a URI database, which accurately searches for a desired entity by using an object identifier, even though there are persons with the same name, and then provides an integrated-search result. Therefore, an inappropriate search result or different information can be prevented from being included.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A system for providing integrated search using a URI (Uniform Resource Identifier) database, the system comprising:
a URI database that stores associated information corresponding to a specific entity as object identifiers;
an entity information processing unit that searches a URI database in accordance with a query input of a user so as to check the type of an entity and provides entity information; and
an integrated-search result providing unit that provides an integrated-search result page for the corresponding entity, based on the entity information provided from the entity information processing unit.

2. The system according to claim 1 further comprising:
a mash-up processing unit that calls an open API (Application Program Interface) on the basis of the entity information provided from the entity information processing unit, calls an inference system, and performs a mash-up by using the corresponding result.

3. The system according to claim 2, wherein the mash-up processing unit includes:
an open API calling section which calls an open API on the basis of the entity information provided from the entity information processing unit;
an inference calling section which calls an inference system on the basis of the entity information provided from the entity information processing unit; and
a mash-up constructing section which constructs a mash-up on the basis of open API information provided from the open API calling section and inference information provided from the inference calling section.

4. The integrated search system according to claim 1, wherein the entity information processing unit includes:
a query receiving section which receives a query from the user;
a URI database searching section which searches for an entity matching the query through the URI database;
an entity type checking section which checks the type of the entity, based on the search result of the URI database searching section; and
an entity information providing section which provides entity information, depending on the type of the entity, the entity information including associated information on the corresponding entity.

5. The system according to claim 1, wherein the integrated-search result providing unit calls an open API or/and an inference system, inserts the entity information provided from the entity information processing unit into a web page so as to construct a page for each entity, and presents the page as an integrated-search result.

6. The system according to claim 2, wherein the integrated-search result providing unit includes:
a mash-up calling section which receives a mash-up result module from the mash-up processing unit;
an open API calling section which calls an open API;
an inference calling section which calls an inference system;
an entity page constructing section which constructs a page for each entity, based on the mash-up result module provided from the mash-up calling section, the open API provided from the open API calling section, the inference system provided from the inference calling section, and the entity information provided from the entity information processing unit; and
an integrated-search result presenting section which provides the page for each entity through a web interface.

7. A method for providing integrated search using a URI database, the method comprising the steps of:
(a) storing associated information corresponding to a specific entity, as object identifiers, into a URI database;
(b) searching the URI database in accordance with a query input of a user so as to check the type of the entity;
(c) providing entity information depending on the type of the entity; and
(d) providing an integrated-search result page for the corresponding entity, based on the provided entity information.

8. The method according to claim 7, wherein in step (d), an open API or/and an inference system is/are called, the provided entity information is inserted into a web page so as to construct a page for each entity, and the page for each entity is presented as an integrated-search result.

9. The method according to claim 7 further comprising the step of:
(e) calling an open API based on the provided entity information, calling an inference system, and performing a mash-up by using the corresponding result, after step (c).

10. The method according to claim 9, wherein in step (d) after step (e), a mash-up result module obtained by the performing of the mash-up is provided, the open API and the inference system are called, the mash-up result module, the open API, the inference system, and the provided entity information are inserted into a web page so as to construct a page for each entity, and the page for each entity is presented as an integrated-search result.
